(19) United States
(12) Patent Application Publication
(10) Pub. No.: US 2009/0287611 A1
(43) Pub. Date: Nov. 19, 2009

(54) Investment portfolio analysis system, dynamic link index computing module of financial asset, and method thereof

(75) Inventor: Jen-Her Jeng, Yunlin County (TW)

Correspondence Address: BACON & THOMAS, PLLC, 625 SLATERS LANE, FOURTH FLOOR, ALEXANDRIA, VA, 22314-1176, US

(73) Assignee: SIFEON KNOWLEDGE-TECHNOLOGY, TAICHUNG CITY (TW)

(21) Appl. No.: 12/153,298

(22) Filed: May 16, 2008

(51) Int. Cl. G06Q 40/00

(52) U.S. Cl. 705/36 R

(57) ABSTRACT

The present invention discloses an investment portfolio analysis system, a dynamic link index computing module of a financial asset and a method thereof. The system is characterized by calculating the dynamic link index with an investment portfolio associating at least two benchmark assets, so that users can evaluate that the investment portfolio's profitability, price drop resistance and linkage of different types of benchmark assets under different economic conditions. The investment portfolio preferably comprises a fund, a stock, a commodity, a foreign exchange, a bond, an option or a shareshares warrant. The benchmark asset preferably comprises a global stock market index, a global bond index, a global commodity index, a global real estate index and a weighted average index of any combination of global currencies.

### BACKGROUND OF THE INVENTION

1. Field of the Invention

The present invention relates to an investment portfolio analysis system, and more particularly to an investment portfolio analysis system for providing a dynamic link index between a financial asset and a benchmark asset.

2. Description of the Related Art

As our living standard has been greatly improved, we pay more attention on financial investments than ever. Therefore, many investment companies and fund houses provide investors with a choice of different combinations of a plurality of financial assets such as funds, stocks, commodities, foreign exchanges, bonds, options and shares warrants. In order to diversify investment risk, many investors' investment portfolios comprise a plurality of financial assets. The profitability and the resistance-to-draw-down of most financial assets need to refer to benchmark assets or indices, such as a global stock market index, a global bond index, a global commodity index, a global real estate index and a weighted average index of any combination of global currencies, however, there is no effective investment portfolio analysis system to assist investors in evaluating different risks and opportunities of an investment portfolio, and thus most of investors simply allocate their capitals in the investments onto a plurality of financial assets without effectively and dynamically adjusting the components of the investment portfolio for responding to the economy environment by representation of the benchmark assets or indices.

Even if some stock funds feature a stable growth and a low fluctuation, the profitability and resistance-to-draw-down of which are not as good as other financial assets during a downturn of the global stock market index since the stock fund is highly correlated to the stock market. Therefore, finding a way for investors to effectively allocate an investment portfolio onto a pool of assets requires immediate attention and feasible solutions.

In view of the shortcomings of the prior art, the inventor of the present invention based on years of experience to conduct extensive researches and experiments, and finally invented an investment portfolio analysis system and a dynamic link index computing module of a financial asset to overcome the shortcomings of the prior art.

### SUMMARY OF THE INVENTION

Therefore, it is a primary objective of the present invention to provide an investment portfolio analysis system and a dynamic link index computing module of a financial asset to achieve the effect of analyzing an investment portfolio effectively.

To achieve the foregoing objective, the present invention provides an investment portfolio analysis system, comprising a storage module, a dynamic link index computing module and a user interface. The storage module is provided for storing a plurality of financial assets and historical dataset thereof, and a plurality of benchmark assets and historical dataset thereof. The dynamic link index computing module is provided for calculating a dynamic link index of each of the financial assets corresponding to the benchmark assets respectively. The user interface is provided for displaying the dynamic link index of the financial assets and allowing an investor to adjust an investment portfolio of the financial assets.

The present invention further provides a dynamic link index computing module of a financial asset for calculating a dynamic link index between a benchmark asset and the financial asset according to a historical dataset of the benchmark asset and a historical dataset of the financial asset. The dynamic link index computing module comprises a rate of return computing unit, a standard deviation computing unit, a covariance computing unit and a dynamic link index computing unit. The rate of return computing unit is provided for calculating a rate of return series of the benchmark asset and a rate of return series of the financial asset according to historical dataset of the benchmark asset and the financial asset. The standard deviation computing unit is provided for calculating a first standard deviation series of the rate of return series of the benchmark asset, and a corresponding second standard deviation series of the rate of return series of the financial asset. The covariance computing unit is provided for calculating a covariance series according to the rate of return series of the benchmark asset and the rate of return series of the financial asset. The dynamic link index computing unit is provided for calculating a linear correlation index series according to the first standard deviation series, the second standard deviation series and the covariance series, and then using a dynamic average value calculated according to the linear correlation index series as the dynamic link index.

To make it easier for our examiner to understand the objective of the invention, its structure, innovative features, and performance, we use preferred embodiments together with the attached drawings for the detailed description of the invention.

### BRIEF DESCRIPTION OF THE DRAWINGS

FIG. 1 is a schematic view of an investment portfolio analysis system in accordance with the present invention;

FIG. 2 is a schematic view of a dynamic link index computing module in accordance with a preferred embodiment of the present invention;

FIG. 3 is a schematic view of a user interface of an investment portfolio analysis system in accordance with a preferred embodiment of the present invention; and

FIG. 4 is a schematic view of a dynamic link index computing method in accordance with the present invention.

### DETAILED DESCRIPTION OF THE PREFERRED EMBODIMENTS

In the related figures of preferred embodiments of an investment portfolio analysis system and a dynamic link index computing module of a financial asset in accordance with the present invention, the same referring numerals are used for the same components in accordance with the present invention.

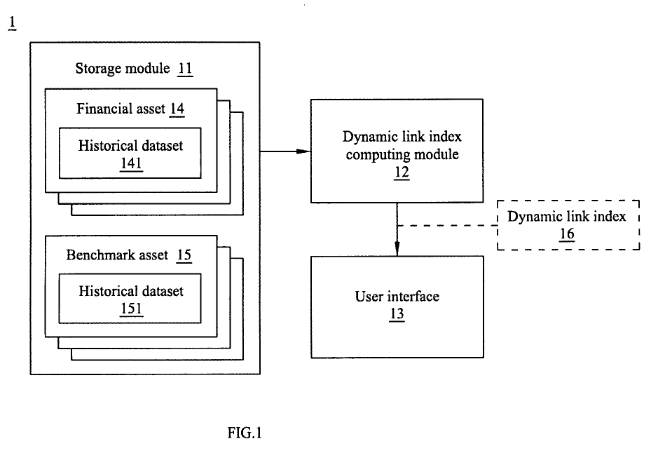

Referring to FIG. 1 for a schematic view of an investment portfolio analysis system in accordance with the present invention, the investment portfolio analysis system 1 comprises a storage module 11, a dynamic link index computing module 12 and a user interface 13. The storage module 11 is provided for storing a plurality of financial assets 14 and historical dataset 141, and a plurality of benchmark assets 15 and historical dataset 151. The dynamic link index computing module 12 is provided for calculating a dynamic link index 16 between each of the financial assets 14 and the benchmark assets 15. The user interface 13 is provided for displaying a dynamic link index 16 between the financial assets 14 and the benchmark assets 15, so that an investor can proceed to select an investment portfolio of the financial assets 14.

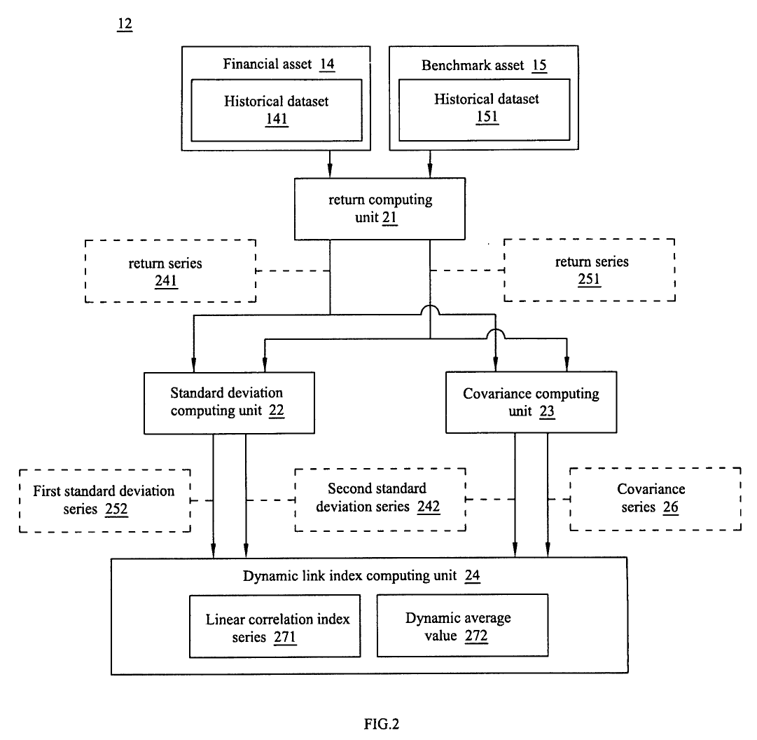

Referring to FIG. 2 for a schematic view of a dynamic link index computing module in accordance with a preferred embodiment of the present invention, the dynamic link index computing module 12 comprises a rate of return computing unit 21, a standard deviation computing unit 22, a covariance computing unit 23 and a dynamic link index computing unit 24. The rate of return computing unit 121 is provided for calculating a rate of return series 241 of the financial asset 14 and a rate of return series 251 of the benchmark asset 15 according to a historical dataset 151 of the benchmark asset 15 and a historical dataset 141 of the financial asset 14 respectively. The standard deviation computing unit 22 is provided for calculating a first standard deviation series 252 of the rate of return series 251 of the benchmark asset 15, and a second standard deviation series 242 of the rate of return series 241 of the financial asset 14.

The covariance computing unit 23 is provided for calculating a covariance series 26 according to the rate of return series 251 of the benchmark asset 15 and the rate of return series 241 of the financial asset 14. The dynamic link index computing unit 24 is provided for calculating a linear correlation index series 271 according to the first standard deviation series 252, the second standard deviation series 242 and the covariance series 26, and using a dynamic average value 272 of the linear correlation index series 271 as a dynamic link index between the financial asset 14 and the benchmark asset 15.

The benchmark asset 15 is preferably a representative capital market data comprising a global stock market index, a global bond index, a global commodity index, a global real estate index and a weighted average index of any combination of global currencies. It is noteworthy to point out that the aforementioned benchmark asset 15 can be set by investors according to their investment strategies. For example, the global stock market index can be generated by calculating a weighted average of the S&P 500 Index, Dow Jones Index, and London Financial Times Index, etc. If an investor has investment in the Asian market, then the Shanghai A Stock Index and Nikkei Index can be added into the global stock market index. The financial asset 14 can be a fund, a stock, a commodity, a foreign exchange, a bond, an option or a shares warrant.

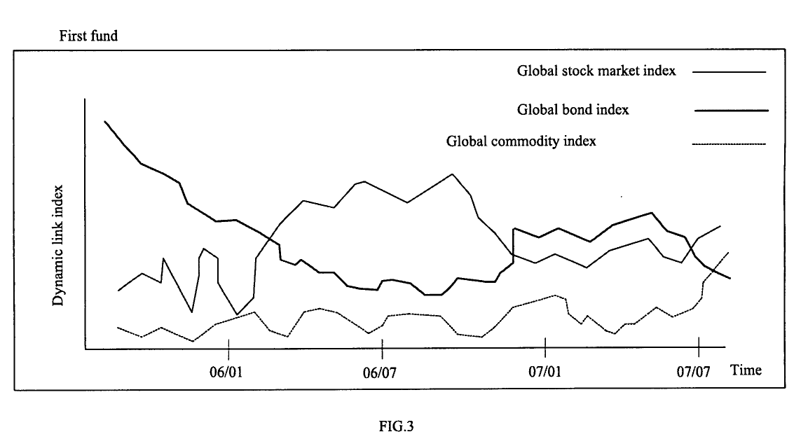

Referring to FIG. 3 for a schematic view of a user interface of an investment portfolio analysis system in accordance with a preferred embodiment of the present invention, the user interface displays a dynamic link index associating a first fund with the global stock market index, the global bond index and the global commodity index. With the user interface, an investor can observe a dynamic link relation associating the first fund with the global stock market index, the global bond index and the global commodity index. In FIG. 3, the dynamic link index with respect to the global stock market index and the global commodity index indicates up trend from January of 2007 to July of 2007, while the dynamic link index with respect to the global bond index shows down trend. If the investor observes that the market is experiencing a collapse of economic bubble in a period of time, the investor can act to lower the investment ratio of related funds within the investment portfolio to avoid a potential risk.

Preferably, in another preferred embodiment, an investment service provider provides a plurality of financial assets S1˜S16, and a dynamic link index thereof associated with five major benchmark assets calculated by the dynamic link index computing module of the present invention is shown in Table 1.

TABLE 1
Prepared on July, 2007

| | Financial Asset | | | | | | | | | | | | | | | |
|---|---|---|---|---|---|---|---|---|---|---|---|---|---|---|---|---|
| Financial Object | S1 | S2 | S3 | S4 | S5 | S6 | S7 | S8 | S9 | S10 | S11 | S12 | S13 | S14 | S15 | S16 |
| Global stock | 0.8 | 0.1 | 0.2 | 0.2 | 0.4 | 0.4 | 0.4 | 0.6 | 0.8 | 0.2 | 0.2 | 0.1 | 0.1 | 0.6 | 0.2 | 0.2 |
| market index | | | | | | | | | | | | | | | | |
| Global bond index | 0.6 | 0.8 | 0.1 | 0.4 | 0.2 | 0.2 | 0.6 | 0.4 | 0.2 | 0.1 | 0.8 | 0.2 | 0.6 | 0.1 | 0.6 | 0.8 |
| Global commodity | 0.4 | 0.6 | 0.4 | 0.1 | 0.8 | 0.6 | 0.1 | 0.8 | 0.4 | 0.6 | 0.1 | 0.6 | 0.8 | 0.4 | 0.4 | 0.6 |
| index | | | | | | | | | | | | | | | | |
| Global real estate | 0.2 | 0.4 | 0.6 | 0.8 | 0.6 | 0.2 | 0.2 | 0.2 | 0.1 | 0.4 | 0.6 | 0.4 | 0.4 | 0.2 | 0.1 | 0.1 |
| index | | | | | | | | | | | | | | | | |
| Global currencies | 0.1 | 0.2 | 0.8 | 0.6 | 0.1 | 0.1 | 0.8 | 0.1 | 0.6 | 0.4 | 0.4 | 0.8 | 0.2 | 0.1 | 0.8 | 0.4 |
| weighted index | | | | | | | | | | | | | | | | |

Since the variety of financial assets offered by investment service provider is limited and the market condition changes all the time, therefore investors can diversify the risk of their investment portfolio by selecting the financial assets having a higher dynamic link index with five major benchmark assets. Even if the benchmark asset drops drastically due to certain uncontrollable factors, the investment portfolio can still gain profits from other benchmark assets, so as to improve the profitability and the price drop resistance of the fund.

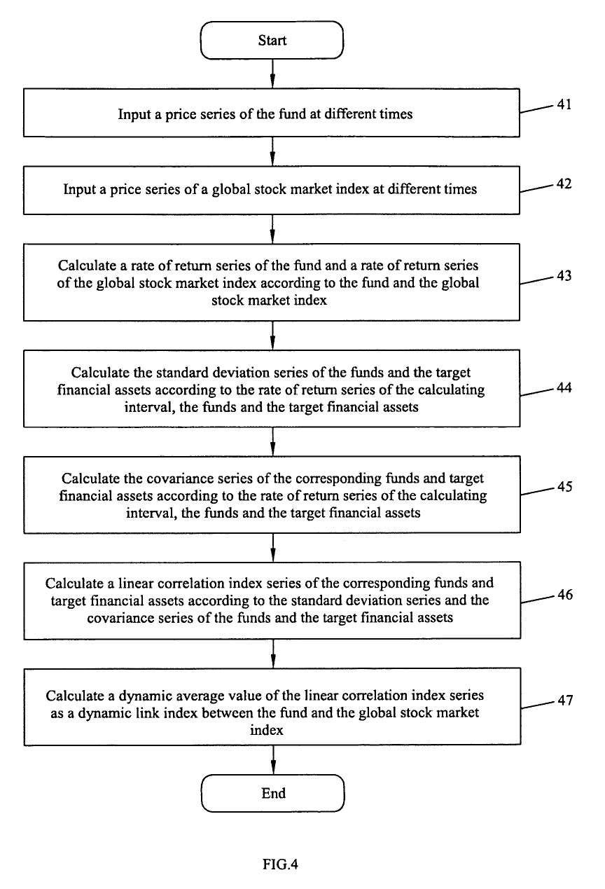

Referring to FIG. 4 for a schematic view of a dynamic link index computing method in accordance with the present invention, the method calculates a dynamic link index between a fund and a global stock market index. The method starts a procedure comprising the following steps:

Step 41: Input a price series V₀, V₁ . . . V_{H} . . . V_{Y+H+1} of the fund at different times, where, V₀ is the price of the fund at time (0), V_{H} is the price of the fund at time (H), and V_{Y+H+T} is the price of the fund at time (Y+H+1).

Step 42: Input a price series V₀^{m}, V₁^{m}, . . . V_{H}^{m} V_{Y+H+1}^{m} of a global stock market index at different times, where V₀^{m} is the price of the benchmark asset at time (0), V_{H}^{m} is the price of the benchmark asset at time (H), and V_{Y+H+1}^{m} is the price of the benchmark asset at time (Y+H+1).

Step 43: Calculate a rate of return series R₁, R₂, . . . , R_{H+1}, . . . , R_{Y+H+1} of the fund during the period from time (1) to time (Y+H+1), and a rate of return series R₁^{m}, R₂^{m}, . . . , R_{H+1}^{m}, . . . , R_{Y+H+1}^{m} of the global stock market index.

Step 44: Set the calculating interval to be H, and calculate the standard deviation D of rate of returns R of H records before each time during the period from time (H) to time (Y+H+1) to produce a standard deviation series D_{H}, D_{H+1}, . . . , D_{Y+H+1} of the fund, and the standard deviation series D_{H}^{m}, D_{H+1}^{m}, . . . , D_{Y+H+1}^{m} of the global stock market index represents an estimated standard deviation D_{H} of rate of H records from R₁ to R_{H}, D_{H+1} is an estimated standard deviation of rate of returns of H records from R₂ to R_{H+1}, D_{H+2} is an estimated standard deviation of rate of returns of H records from R₃ to R_{H+2}, and D_{H}^{m} is a standard deviation of H records from R₁^{m} to R_{H}^{m}.

Step 45: Set the calculating interval to be H, and calculate the covariance series C_{H}, C_{H+1}, . . . , C_{Y+H+1} of rate of returns R of H records and rate of returns R^{m} of H records before each time during the period from time (H) to time (Y+H+1), where C_{H} is an estimated covariance from R₁ to R_{H} and R₁^{m} to R_{H}^{m}, C_{H+1} is an estimated covariance series from series R₂ to R_{H+1} and series R₂^{m} to R_{H+1}^{m}.

Step 46: Calculate a linear correlation index series L_{H}, L_{H+1}, . . . , L_{Y+H+1} according to the standard deviation series D_{H}, D_{H+1}, D_{Y+H+1}, the standard deviation series D_{H}^{m}, D_{H+1}^{m}, D_{Y+H+1}^{m} and the covariance series C_{H}, C_{H+1}, . . . , C_{Y+H+1}. In a preferred embodiment, a linear correlation index is calculated according to the following formula:

$${L}_{H} = \frac{{C}_{H}}{{D}_{H} \times {D}_{H}^{m}}$$

Step 47: Calculate a dynamic average value of the linear correlation index series L_{H}, L_{H+1}, . . . , L_{Y+H+1} as a dynamic link index between the fund and the global stock market index.

While the invention has been described by way of examples and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. An investment portfolio analysis system, comprising:
a storage module, for storing a plurality of financial assets and historical dataset thereof, and a plurality of benchmark assets and historical dataset thereof;
a dynamic link index computing module, for calculating a dynamic link index of each of said financial assets corresponding to said benchmark assets respectively;
a user interface, for displaying said dynamic link index of said financial assets, thereby allowing an investor to adjust an investment portfolio of said financial assets.

2. The investment portfolio analysis system of claim 1, wherein said benchmark asset comprises a global stock market index, a global bond index, a global commodity index, a global real estate index and a weighted average index of any combination of global currencies.

3. The investment portfolio analysis system of claim 1, wherein said financial asset is a fund, a stock, a commodity, a foreign exchange, a bond, an option or a shares warrant.

4. The investment portfolio analysis system of claim 1, wherein said dynamic link index computing module comprises a rate of return computing unit, a standard deviation computing unit, a covariance computing unit and a dynamic link index computing unit.

5. A dynamic link index computing module of a financial asset, for calculating a dynamic link index between a benchmark asset and a financial asset according to a historical dataset of said benchmark asset and a historical dataset of said financial asset, and said dynamic link index computing module comprising:
a rate of return computing unit, for calculating a rate of return series of said benchmark asset and a rate of return series of said financial asset according to historical dataset of said benchmark asset and said financial asset;
a standard deviation computing unit, for calculating a first standard deviation series of said rate of return series of said benchmark asset, and a corresponding second standard deviation series of said rate of return series of said financial asset;
a covariance computing unit, for calculating a covariance series according to said rate of return series of said benchmark asset and said rate of return series of said financial asset; and
a dynamic link index computing unit, for calculating a linear correlation index series according to said first standard deviation series, said second standard deviation series and said covariance series, and then using a dynamic average value calculated according to said linear correlation index series as said dynamic link index.

6. The module of claim 5, wherein said benchmark asset comprises a global stock market index, a global bond index, a global commodity index, a global real estate index and a weighted average index of any combination of global currencies.

7. The module of claim 5, wherein said financial asset is a fund, a stock, a commodity, a foreign exchange, a bond, an option or a shares warrant.

8. A dynamic link index computing method for a financial asset, for calculating a dynamic link index between a benchmark asset and a financial asset according to a historical dataset of the benchmark asset and a historical dataset of said financial asset, and said dynamic link index computing module comprising:
calculating a rate of return series of said benchmark asset and a rate of return series of said financial asset according to historical dataset of said benchmark asset and said financial asset calculating a first standard deviation series of said rate of return series of said benchmark asset, and a corresponding second standard deviation series of said rate of return series of said financial asset;
calculating a covariance series according to said rate of return series of said benchmark asset and said rate of return series of said financial asset; and
calculating a linear correlation index series according to said first standard deviation series, said second standard deviation series and said covariance series, and then using a dynamic average value calculated according to said linear correlation index series as said dynamic link index.

9. The method of claim 8, wherein said benchmark asset comprises a global stock market index, a global bond index, a global commodity index, a global real estate index and a weighted average index of any combination of global currencies.

10. The method of claim 8, wherein the financial asset is a fund, a stock, a commodity, a foreign exchange, a bond, an option or a shares warrant.
